(19) United States
(12) Patent Application Publication
(10) Pub. No.: US 2014/0058927 A1
(43) Pub. Date: Feb. 27, 2014

(54) SYSTEM AND METHOD OF A PROVIDER MANAGEMENT SYSTEM

(71) Applicant: LEAF HOLDINGS, INC., Cambridge, MA (US)

(72) Inventor: Aron SCHWARZKOPF, Boston, MA (US)

(21) Appl. No.: 13/793,549

(22) Filed: Mar. 11, 2013

Related U.S. Application Data
(60) Provisional application No. 61/693,566, filed on Aug. 27, 2012.

(51) Int. Cl. G06Q 20/22

(52) U.S. Cl. CPC G06Q 20/227
USPC 705/39; 705/35

(57) ABSTRACT

Systems and methods for selecting a payment provider. A request for provider information is received. The request includes merchant information associated with a merchant. A provider is selected from one or more providers as a function of the merchant information. The merchant is registered with the selected provider.

### CROSS REFERENCE TO RELATED APPLICATIONS

This application claims priority to and the benefit of U.S. Provisional Application No. 61/693,566, filed Aug. 27, 2012, entitled, “System and Methods of a Provider Management System,” the disclosure of which is hereby incorporated by reference in its entirety.

### BACKGROUND

Embodiments described herein relate generally to methods and systems for facilitating selection of a payment service provider (PSP) for processing one or more transactions. The retail industry is highly competitive and often survival depends on the merchant providing customers with the utmost quality of service, one aspect of which is providing customers with a variety of payment methods. Such payment methods can include credit/debit/gift cards, bank-based payments such as direct debit, bank transfer, real-time bank transfer based on online banking, contactless mobile payments (e.g. via SMS, direct mobile billing, geo-fencing, quick response codes, near field communication or NFC, audio signals, and so on), virtual currency (e.g. as associated with social media, virtual worlds, online gaming, and/or other online accounts), and/or the like. In most cases, merchants employ a third-party payment processor such as a payment service provider (PSP) for facilitating the financial aspects of transactions with the customer. Using a PSP can benefit merchants in various ways, including: connectivity to multiple payment networks; independence from managing technical and business relationships with each payment network; further transaction security due to regulatory oversight of PSPs and any risk management services provided by the PSPs. Examples of current PSPs include PayPal™, Amazon Payments™, Braintree, LevelUp, Dwolla, First Data™, Chase Paymentech™, Merchant Warehouse, and so on.

Often, there are several PSPs a merchant can choose from, requiring a merchant to request and evaluate the terms and conditions of each PSP separately. However, even after a merchant selects a PSP, the terms and conditions of not only the selected PSP, but other non-selected PSPs can change. For example, a merchant can initially select PayPal™ based on low transaction fees, but after a few months Amazon Payments™ may be offering a lower transaction fee than PayPal™. As a result, it might be beneficial for the merchant to be aware of these changes, and to be able to switch PSPs for a more desirable contract. There is hence a need to allow a merchant not only to compare PSP offerings, but also to dynamically update the merchant on the latest PSP offerings, and to facilitate real-time switching to a different PSP.

### SUMMARY

Systems and methods for selecting a payment provider are described herein. In some embodiments, a request for provider information is received. The request includes merchant information associated with a merchant. A provider is selected from one or more providers as a function of the merchant information. The merchant is registered with the selected provider. In some embodiments, at least a portion of the merchant information is transmitted to at least one provider of the one or more providers as a function of the merchant information. Merchant-specific provider information is received from the one or more providers in response to the transmitting. At least a portion of the merchant-specific provider information is transmitted to the merchant in response to the request for provider information. A selection of a provider of the one or more providers is received from the merchant as the selected provider.

### BRIEF DESCRIPTION OF THE DRAWINGS

FIG. 1 is a system of the invention, according to an embodiment.

FIG. 2 is a schematic illustration of the payment system of FIG. 1, according to an embodiment.

FIG. 3 is a schematic illustration of the receipt system of FIG. 1, according to an embodiment.

FIG. 4 is a flowchart of a method of selecting a payment provider, according to an embodiment.

FIGS. 5A-B are exemplary interfaces for payment provider registration, according to an embodiment.

FIG. 6 is an exemplary interface for payment provider selection by a merchant, according to an embodiment.

### DETAILED DESCRIPTION

As used in this specification, the singular forms “a,” “an” and “the” include plural referents unless the context clearly dictates otherwise. Thus, for example, the term “a network” is intended to mean a single network or a combination of networks.

Systems and methods that enable real-time PSP selection by a merchant from a listing of available PSPs are described herein. Embodiments described herein provide a unified and single-point approach for merchants to become aware of existing PSPs and the PSP offerings, and empower the merchant to make an informed decision based on a direct comparison of the PSP offerings such as, for example, transaction rates. The PSP market is extremely competitive with respect to obtaining new customers (e.g., merchants) and/or for maintaining existing customers, therefore, aspects of the systems and methods described herein can result in improved offerings for the merchant/customer by further increasing competition. Further, aspects of the systems and methods described herein are scalable for use by a large number of merchants, which provides an incentive for PSPs to make their offerings available to merchants through the systems and methods described herein since it provides access to a potentially larger pool of customers (i.e. the merchants) for the PSPs. The term PSP can refer to any entity involved in transaction processing including, for example, a point-of-sale (PoS) provider, an aggregator such as a payment aggregator, a credit card network, a bank, a mobile money provider, a virtual currency provider, and/or the like.

The systems and methods described herein allow deficiencies of pre-existing approaches to be avoided. For example, typically a merchant must proactively discover existing PSPs, request rate and other information separately from each PSP while providing repetitive merchant information to each, manually compare merchant-specific PSP information while accounting for different terminologies used by different PSPs, and so on. Pre-existing approaches also involve merchants making decisions based on marketing pressure (e.g. aggressive salespersons) and/or messages from few but not all available PSPs. In both of these scenarios, a merchant can make a poorly informed choice that does not yield the best available transaction rate, overall merchant support, and/or service for the merchant.

In some embodiments, the systems and methods described herein permit recognition of a user during payment for a transaction using a unique payment identifier such as a credit card, application of a loyalty discount associated with the user, and delivery of a paperless receipt to one or more digital accounts of the user. In this manner, aspects of the invention can operate in a manner as disclosed in co-pending U.S. patent application Ser. No. 13/793,061, entitled, “SYSTEM AND METHOD FOR PROVIDING REAL-TIME LOYALTY DISCOUNTS AND PAPERLESS RECEIPTS”, filed on Mar. 11, 2013, the disclosure of which is incorporated in its entirety herein by reference (“the Real-Time Loyalty application”).

In some embodiments, a PSP management system receives a request from a merchant for PSP information. The request can include a bid request for individual PSPs to handle transactions generated by and/or at the merchant, such as at a point of sale (PoS) device of the merchant, for example. In some embodiments, the merchant request can include merchant information relevant for determining merchant-specific PSP information. In some embodiments, the merchant has a pre-existing merchant profile with the PSP management system (e.g. the merchant registered with the PSP management system previously) that has merchant information associated therewith, and the merchant request simply identifies the merchant associated with the request. In some embodiments, the merchant has a pre-existing profile with the PSP management system that has merchant information associated therewith, and the merchant request includes additional merchant information specific to the request. In some embodiments, the PSP management system requests additional merchant information from the merchant based on the request. In some embodiments, the requested information may be specified as mandatory or preferred. For example, the PSP management system may communicate to the merchant that the additional information is required to receive a bid from a particular PSP, or the PSP management system may communicate to the merchant that the additional information, though not required, may result in a better rate for the merchant, and so on.

The merchant information can include any suitable information typically required of business and/or individual entities by law or otherwise, and can include, but is not limited to, a specification of one or more of the following: a first name, a last name, an email address, a business type, an average transaction amount, a business address, an owner address, a business legal name, a doing business as (d/b/a) name, a business legal entity type (e.g. LLP, LLC, etc.), a phone number, a duration of operation of business, an expected and/or known highest transaction amount, an owner's social security number, an owner's percentage of equity ownership, a tax identifier, a bank routing number, a bank account number, an owner's date of birth, a specification of provider services desired by the merchant, a selection of a provider, an approval to share the merchant information with the one or more providers, an acceptance of terms and conditions for one or more providers, account settings of the merchant, and/or the like

In some embodiments, the merchant information can further include any suitable PSP information for filtering the set of PSPs associated with any aspect of the merchant request. For example, the merchant-provided PSP information can explicitly specify which PSPs the merchant wishes to receive bids from. As another example, the merchant-provided PSP information can specify that only PSPs that offer a qualified swipe rate of 2.5% should be shown to the merchant in response to the request (e.g. a merchant acceptance criterion). Accordingly, in some embodiments, the merchant information further includes one or more of the following: a specification of providers, a merchant acceptance criterion, a maximum rate, a maximum qualified swipe rate, a maximum qualified keyed rate, a maximum fee, a maximum monthly fee, a maximum value of a monthly minimum amount, a maximum cancellation fee, a maximum authorization fee, a maximum chargeback fee, a maximum debit rate, a maximum base fee, and/or the like.

In some embodiments, at least a portion of the merchant information can be mandatory. In some embodiments, the merchant information designated as mandatory can include a specification of PSP information, as described above.

In some embodiments, the PSP management system transmits the merchant's request to one or more PSPs. The determination of which PSPs receive the merchant request may be performed in any suitable manner based on the merchant information and based on the one or more PSPs. In some embodiments, the merchant-provided PSP information is employed to select which PSPs receive the bid request. In some embodiments, a PSP has a pre-existing PSP profile with the PSP management system (e.g. the PSP registered with the PSP management system previously). The pre-existing PSP profile can have PSP information associated therewith such as, for example, PSP acceptance criterion for receiving bid requests and the PSP management system can determine whether the PSP receives the merchant request based on the acceptance criterion. For example, the PSP acceptance criterion can specify that the PSP should only receive requests from merchants having at least a pre-specified average transaction amount. As another example, the PSP acceptance criterion can specify that the PSP should only receive requests from merchants that provide a bank routing number (i.e. the PSP can have mandatory information requirements).

In some embodiments, the PSP information includes a specification of one or more of the following: mandatory merchant information, desirable merchant information, optional merchant information; a fee, a monthly fee, a monthly minimum, a cancellation fee, an authorization fee, a chargeback fee, a debit value, an annual fee, a nuisance fee, a statement fee, a batch fee, an early termination fee, a chargeback fee, a rate, a qualified rate, a qualified swipe rate, a mid-qualified rate, a qualified key rate, a non-qualified rate, a gift card rate, a qualified rate for a particular credit card network, terms and conditions, a corporate logo, pre-authorization criterion, and/or the like.

In some embodiments, the PSP management system receives the PSP acceptance criterion upon transmitting the merchant request to the PSP, and is further configurable to request additional information from the merchant required to fulfill the PSP acceptance criterion. In this manner, the PSP management system can ensure that the merchant receives consideration from each PSP to the fullest extent possible, and can further ensure that each PSP does not lose out on potential business simply because the merchant inadvertently omitted certain information and/or didn't deem necessary to provide particular merchant information to the PSP.

In some embodiments, the PSP management system transmits at least a portion of the merchant information to each PSP determined to receive the merchant request. In some embodiments, the portion of the merchant information for each PSP is independently selected based on the PSP information; i.e. based on what the PSP requires to provide a bid in response to the merchant's request. In some embodiments, the portion of the merchant information transmitted to the PSPs is based on a privacy standard.

In response to transmitting the portion of the merchant information the PSP management system receives PSP bid information (e.g. a bid for the merchant's transaction business) from each PSP, and communicates this merchant-specific PSP information to the merchant. The PSP information can include, for example, the PSP's proposed per-transaction fee, any additional fees, and/or the like. In some embodiments, the PSP information received by the PSP management system is specific to the merchant request, i.e. is merchant-specific PSP information.

The PSP management system can transmit at least a portion of the received merchant-specific PSP information to the merchant. In some embodiments, the transmitted merchant-specific PSP information is based on the merchant acceptance criterion, as described herein. In some embodiments, the PSP management system can be configured to select a recommended PSP of the PSPs that provide the merchant-specific PSP information, and the transmitted merchant-specific PSP information can include a specification of the recommended PSP. The recommended PSP may be selected in any suitable manner. For example, the recommended PSP can be one that provides the lowest qualified swipe rate. As another example, the recommended PSP can be selected based on a special promotion and/or a contractual agreement between the PSP and an entity associated with the PSP management system.

In some embodiments, the transmitted merchant-specific PSP information can include third party information about each PSP that provides merchant-specific PSP information to aid the merchant in making a selection. The third party information can include, for example, public ratings and/or reviews from any suitable source such a third-party rating service, from social media, and/or the like.

As described above, the PSP management system, in some embodiments, is operable to transmit at least a portion of the merchant request to one or more PSPs. In some embodiments, the merchant-specific PSP information for at least one PSP can be directly determined by the PSP management system itself. For example, in some embodiments, the PSP management system can compare the received merchant information against the PSP information stored as part of a PSP registration profile/information. When the PSP information includes any PSP acceptance criterion for a merchant, and further authorizes the PSP management system to bid for the merchant's business on the PSP's behalf if the PSP acceptance criterion is met (e.g. when the PSP information include pre-authorization criterion, such as a contract), the PSP management system can generate the merchant-specific PSP information on behalf of the PSP, and provide it to the merchant on behalf of the PSP. In this manner, the time to process the merchant request can be reduced. Additionally, the PSP is spared the burden of evaluating merchant information, and can operate as a simpler business model that only requires providing merchant acceptance criterion to the PSP management system. An entity for the PSP management system can, in turn, benefit from charging additional fees from the PSP for such processing on its behalf.

In response to the transmitted merchant-specific provider information for one or more PSPs, the PSP management system can receive a selection of a PSP from the merchant for processing the merchant's transactions, and register the merchant with the selected PSP. In some embodiments, registering includes communicating a notification of the selection to the selected PSP. In some embodiments, registering includes facilitating initial connectivity and/or registration of the merchant with the selected PSP. In some embodiments, the selected PSP and the merchant can communicate directly thereafter. In some embodiments, the PSP management system can receive subsequent transaction information (e.g. payment information) from the merchant, and route at least a portion of the transaction information to the selected PSP for processing, and generally continue to serve as a communication interface/conduit between the merchant and its selected PSP. In some embodiments, registering includes receiving a notification that the selected PSP has in fact accepted the merchant's business.

In some embodiments, the pre-authorization criterion associated with the PSP information of the selected PSP authorizes the PSP management system to accept the merchant's selection, and to register the selected PSP with the merchant by simply forwarding all subsequent payment information from the merchant to the selected PSP. In this manner, the merchant receives immediate registration with the selected PSP, and the selected PSP only has to concern itself with processing transactions that it receives.

In some embodiments, the PSP management system is operable to store the data/information exchanged and/or generated by the functionality described above in one or more databases. For example, the PSP management system can enable storage of the merchant information, the PSP information, the merchant-specific provider information, information linking a merchant to its selected PSP, and/or the like.

Independent of how the PSP is registered, in some embodiments, aspects of the PSP management system can be operable to receive and/or periodically probe the one or more PSPs for updated, merchant-specific PSP information. For example, a PSP can change service terms that affect the monthly fee a merchant using that PSP would pay. In some embodiments, the PSP management system can receive the updated merchant-specific PSP information based on the service change, and communicate the change to the merchant. In some embodiments, the PSP management system can suspend the merchant-PSP relationship if it determines that the service change does not meet the merchant acceptance criterion any more. In some embodiments, the PSP management system can act based on setting provided by the merchant as part of the merchant information (e.g. the merchant can specify whether to suspend transactions upon service change or not). In this manner, a merchant can be notified of any service changes in its selected PSP, and can choose its course of action immediately or beforehand (i.e. via pre-specified settings).

In some embodiments, the PSP management system can periodically, and/or when a special promotion occurs, and/or upon the merchant's request, resend the merchant information to one or more PSPs to obtain updated merchant-specific PSP information, and to communicate the updated merchant-specific PSP information to the merchant. The merchant can then choose to stay with her selected PSP, or to switch to another PSP if better terms/rates are now available, based on the updated merchant-specific PSP information. In this manner, aspects of the PSP management system can enable a merchant to monitor non-selected PSPs at a merchant-specified/fixed periodicity and/or on demand to see if the merchant can avail of a better rate, a promotion, and/or the like.

Hence, in some embodiments, the PSP management system can receive a selection of a new PSP from the merchant and, facilitate real-time migration of the merchant from the previously selected PSP to the newly selected PSP. In some embodiments, this includes unregistering the merchant from the previously selected PSP, and further includes registering the merchant with the newly selected PSP. Unregistering the merchant from the previously selected PSP may be done in any suitable manner, including one or more of the following: terminating transactional connectivity between the merchant and the previously selected PSP, negotiating a termination of contract between the merchant and the previously selected PSP (e.g. termination fees), and/or the like. In some embodiments, the PSP management system is pre-authorized by the previously selected PSP and/or the newly selected PSP to perform the unregistering and/or the registering, respectively, of the merchant.

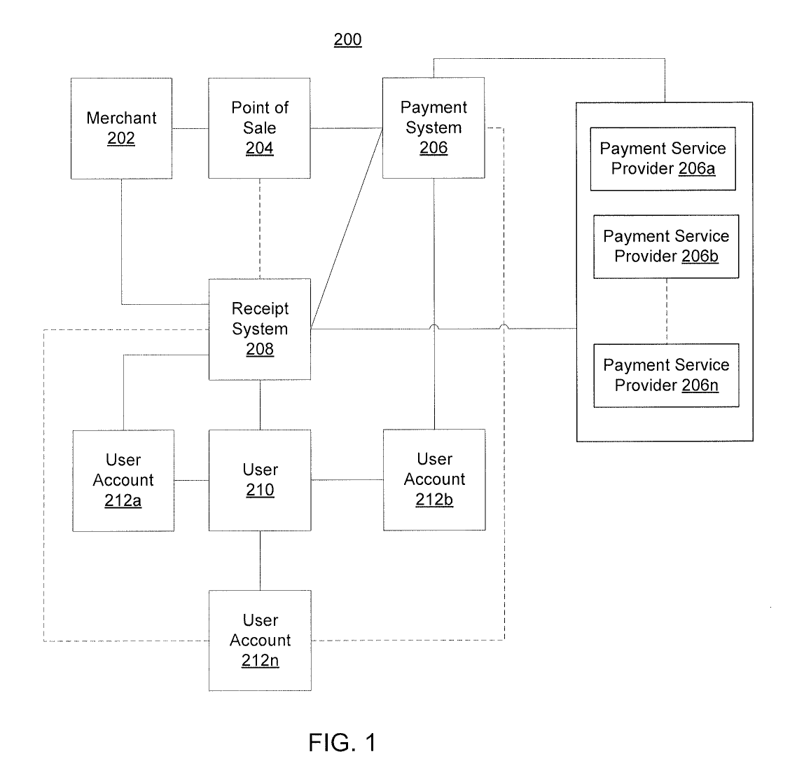

Having described methods in which a merchant can select a payment provider, FIG. 1 illustrates an environment or system 200 within which aspects of the method can be implemented. The system 200 is operable for selection of payment providers by merchants for processing a transaction of the merchant, such as by a user/customer at the merchant. In some embodiments, the system 200 is operable for use by a merchant 202 having a merchant account with a payment system 206 and/or a receipt system 208 to select one of the payment service providers 206a-206n for transaction processing.

In some embodiments, aspects of the system 200 can operate within the context of a transaction system that generates transaction information from separately received order information and payment information, as generally disclosed in U.S. Provisional Application No. 61/660,186 filed Jun. 15, 2012, titled “APPARATUS AND METHODS OF A TRANSACTION SYSTEM”, the disclosure of which is incorporated herein in its entirety. In some embodiments, aspects of the system 200 can operate within the context of a real-time loyalty and paperless receipt system, as generally disclosed in the Real-Time Loyalty application, the disclosure of which is incorporated herein in its entirety.

The system 200 includes a receipt system 208 and a payment system 206, each of which can be in communication with one or more payment service providers 206a, 206b . . . 206n. The various components of the system 200 can be in communication as indicated by lines in FIG. 1 via a network, which may be any type of network (e.g., a local area network or LAN, a wide area network or WAN, a virtual network, a telecommunications network, and/or the internet) implemented as a wired network and/or a wireless network. Any or all communications may be secured (e.g., encrypted) or unsecured, as is known in the art. Each of the merchant 202, point-of-sale (PoS) 204, payment system 206, payment service providers 206a-206n, receipt system 208, and user 210 can include a personal computer, a server, a work station, a tablet, a mobile device, a cloud computing environment, an application or a module running on any of these platforms, and/or the like. Additionally, it is understood that merchant 202 and user 210 can be any suitably representative human entity, such as an actual person, an employee, and so on. Hence, user accounts 212a, 212b, 212n and so on might be that of a person depicted as user 210, and not necessarily tied to a device corresponding to the user 210.

In some embodiments, at least some aspects of the payment system 206 and the receipt system 208 can be commonly implemented on the same device, and/or can be commonly owned. In some embodiments, at least one of the payment service providers 206a-206n is a third party service for executing payments.

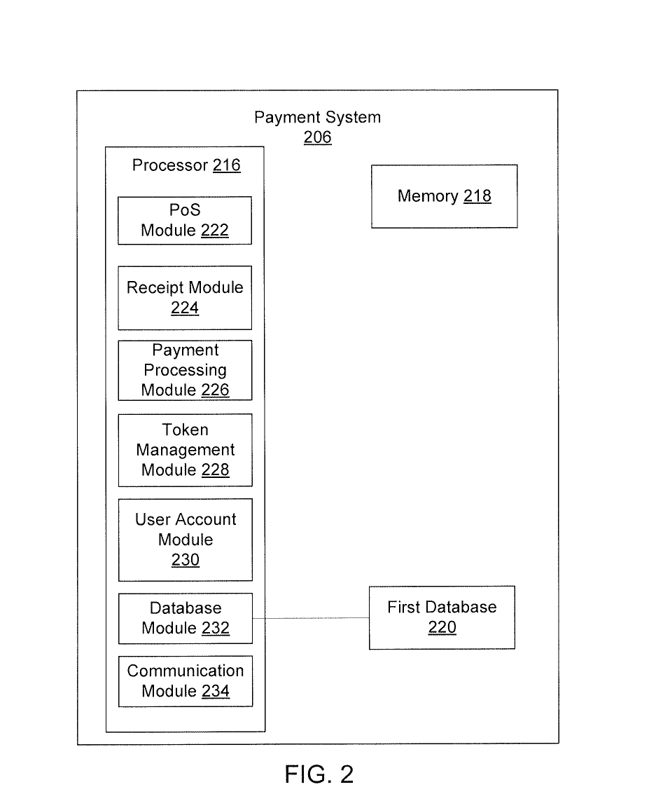

FIG. 2 illustrates the payment system 206 according to some embodiments. The payment system 206 includes at least a processor 216 and a memory 218. The payment system 206 may additionally include a first database 220, although it is understood that the first database 220 can be outside the device/system context of the payment system 206 (yet within the system 200) while still accessible and usable by the payment system. In some embodiments, the memory 218 includes the first database 220.

Still referring to FIG. 2, the processor 216 can include a point of sale (PoS) module 222, a receipt module 224, a payment processing module 226, a token management module 228 and a user account module 230. The processor 216 can also include a database module 232 for reading and/or updating the first database 220. The processor 216 can also include a communications module 234 for establishing and managing network connectivity of the payment system 206 within the system 200.

The functionality of the various modules of the processor 216 can overlap, and/or two or more modules can be combined. For example, the PoS module 222 and the token management module 228 may be partly or wholly combined in some embodiments since both manipulate the payment identifier (e.g. a token). As another example, the receipt module 224 and the user account module 230 can be combined, since both can act in combination to deliver paperless receipts and registration links to pending users. Furthermore, each of the modules may be in seamless communication with each other module.

The PoS module 222 and the token management module 228 can be configured in a manner as disclosed in the Real-Time Loyalty application. In other words, the PoS module 222 can be configured to receive the payment information and/or payment identifier information from the PoS 204 and transmit the received payment identifier to the token management module 228. The token management module 228 is configurable to receive the payment identifier from the PoS module 222, and to transmit the payment information, including any discount information, to the payment processing module 226.

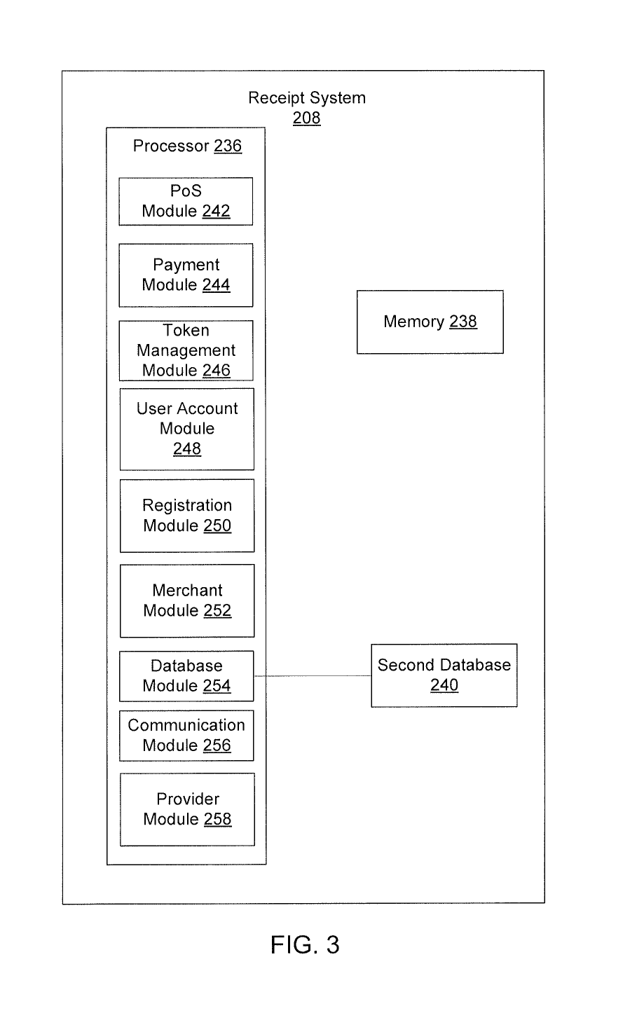

The payment processing module 226 can be configured to receive the payment information and any discount information from the token management module 228, and is configurable to execute the payment for the transaction after applying the discount information. In some embodiments, the payment processing module 226 communicates with the PoS 204 (e.g. via PoS module 222) to confirm that the user 210 intends to apply the discount information to the transaction. In some embodiments, the payment processing module 226 does not execute the payment but transmits the payment information to a third party entity such as one of the payment service providers 206a-206n, and receives confirmation or failure of the success of the transaction from the payment processor. In some embodiments, the payment processing module 226 transmits the payment information to a payment processor (e.g. the payment processor 206a) that has been previously selected by the merchant 202 for processing transactions originating at the PoS 204 associated with the merchant 202. In some embodiments, the payment processing module 226 determines the selected payment processor 206a based on information in the first database 220 that links the merchant 202 with the payment processor 206a. In some embodiments, the payment processing module 226 determines the selected payment processor 206a based on information received from the receipt module 208, such as from the provider module 253 (see FIG. 3) of the receipt module 208. The provider 226 is further configurable for transmitting the processed payment information to the receipt module 224.

In some embodiments, the payment processing module 226 can be configured to suspend or hold the payment information prior to execution, and to send at least part of the suspended information to the receipt system 208 (via receipt module 224) for determining the latest loyalty and/or any discount information to be applied to the payment information, as described herein. The payment processing module 226 can be further configured to receive the latest discount information from the receipt module 224 and to apply the determined loyalty to the suspended transaction. In some embodiments, the payment processing module 226 can be further configured to receive a specification of the selected provider 206a for processing the suspended transaction.

In some embodiments, the payment processing module 226 communicates with the PoS 204 (e.g. via PoS module 222) to confirm that the user 210 intends to apply the discount information to the suspended transaction. Applying the discount information may include, but is not limited to, one or more of providing a reward to the user, applying a discount to the transaction that alters an amount of a payment associated with the transaction, and/or the like. After applying the discount information, the payment processing module 226 may release the suspended transaction for processing in any suitable manner, including transmitting the transaction information to the selected provider 206a as described above.

The receipt module 224 receives the processed and/or suspended payment information from the payment processing module 226, and is configurable to transmit the payment information to the receipt system 208, and can generally be configured in a manner as disclosed in the Real-Time Loyalty application. In embodiments where the payment information is suspended by the payment processing module 226, the receipt module 224 is further configurable to transmit the suspended payment information to the receipt system 208 and in response, to receive the latest discount information from the receipt system 208 for applying to the suspended transaction. In some embodiments, the receipt module 224 is further configurable to receive a specification of a selected payment service provider for processing the transaction.

FIG. 3 illustrates the receipt system 208 according to some embodiments. The receipt system 208 includes at least a processor 236 and a memory 238. The receipt system 208 may additionally encompass a second database 240, although it is understood that the second database 240 can be outside the device/system context of the receipt system 208 (yet within the system 200) while still accessible and usable by the receipt system. In some embodiments, the memory 238 includes the second database 240.

The processor 236 can include a point of sale (PoS) module 242, a payment module 244, a token management module 246, a user account module 248, a registration module 250, a merchant module 252, and a provider module 258. The processor 236 can also include a database module 254 for reading and/or updating the second database 220. The processor 236 can also include a communications module 254 for establishing and managing network connectivity of the receipt system 208 within the system 200. The functionality of the various modules of the processor 236 can overlap, and/or two or more modules can be combined. Furthermore, each of the modules may be in seamless communication with each other module.

The PoS module 242 of the receipt system 208 is configurable to receive data directly from the PoS 204 and/or from the merchant 202, as best illustrated in FIG. 1. In this manner, the receipt system 208 can receive less sensitive transaction information from the merchant directly from the PoS 204, and relatively more sensitive information such as payment information via the payment system 206. Examples of less sensitive transaction information include, but is not limited to, a stock keeping unit (SKU), and/or the like. In some embodiments, the PoS module 242 communicates transaction and non-transaction related information to the PoS 204, such as advertisements, registration information, product ratings, and/or the like. In some embodiments, the PoS module 242 and the receipt system 206 are commonly owned or otherwise permitted to directly communicate as described here. In other embodiments, the PoS 204 is a third party device with respect to the receipt system 206, and cannot communicate with the receipt system. Hence, the PoS module 242 can be optional.

The payment module 244 is configurable to receive the payment identifier and other transaction-based information from the payment system 206. The payment module 244 is also configurable to communicate the received information to the token management module 246. The payment module 244 is further configurable to communicate an indication to the payment system 206 of whether the user 210 is pending or registered. Said another way, the payment module 244 communicates to the payment system 206 whether to transmit a paperless receipt and registration link to the pending user account 212a (for pending users, see scenarios 1.1, 1.2, 2.1), or whether the receipt system 208 will deliver a paperless receipt to the registered user account 212b. The payment module 244 is further configured to communicate the payment information and any other transaction-related information (e.g. received from the PoS module 242) to the merchant module 252 for determining discount information.

The token management module 246 is configurable to receive the payment information and/or identifier from the payment module 244, and can also communicate with the merchant module 252 to receive updated discount information to be associated with the payment identifier and/or the user 210 in the second database 240.

The merchant module 252 is configurable to receive the transaction information, including payment information, from the payment module 244. The merchant module 252 is further configurable to determine discount information based on, among other factors, the received transaction information. Determining discount information may refer to, but is not limited to, one or more of: determining a reward to be provided to the user 210, determining a discount that alters the amount of the transaction, tracking the user's purchasing habits, updating the customer's purchasing habits in a database (not shown), checking a campaign of the merchant (e.g. a customer loyalty campaign) for available discounts and/or offers that can be applied to the transaction and/or to future transactions based on the transaction, checking a social media profile of the user 210, checking for the user's loyalty to the merchant against a social media profile of the customer, and/or the like. The determined discount information may be communicated to the payment system 206 (e.g. via the payment module 244) and optionally, to the PoS 204 (e.g. via the PoS module 242). In some embodiments, the merchant module 252 updates a registered social media account (e.g. the user account 212b) of the user 210 to reflect the determined discount information, and optionally communicates the discount information to other accounts (e.g. the user accounts 212a, 212n) of the user. In some embodiments, the loyalty system 150 updates a transaction database (not shown) with the determined discount and any other relevant transaction information.

In some embodiments, the merchant module 252 enables the merchant 202 to set up a merchant profile that specifies how a user of the merchant (e.g. the user 210) may earn discounts for purchases. The merchant profile may be accessible to the merchant 202 upon providing relevant identifying credentials, as is known in the arts. The merchant module 252 may additionally permit a merchant to view any relevant data of current and/or past transactions by accessing the second database 240. In some embodiments, the merchant module 252 is configurable to provide offerings, merchant-specific messages, and other information to the PoS module 242 for display on the PoS 204. In some embodiments, the merchant module 252 permits the registered merchant 202 to view user ratings and other user-specific information by accessing the user's registered account. The user data presented to the merchant 202 can be filtered or otherwise anonymized to remove personally identifiable data.

In some embodiments, the merchant module 252 is further configured to enable the merchant 202 to select one of the payment service providers 206a-206n for processing transactions at the PoS 204. In some embodiments, the merchant module 252 is configured to receive a request for provider information from the merchant 202. The request can include merchant information associated with the merchant. In some embodiments, the merchant information can include one or more of the following: a first name, a last name, an email address, a business type, an average transaction amount, a business address, an owner address, a business legal name, a doing business as (d/b/a) name, a business legal entity type, a phone number, a duration of operation of business, a highest transaction amount, an owner's social security number, an owner's percentage of equity ownership, a tax identifier, a bank routing number, a bank account number, an owner's date of birth, a specification of provider services desired by the merchant, a selection of a provider, an approval to share the merchant information with the one or more providers, an acceptance of terms and conditions for one or more providers, and account settings of the merchant. In some embodiments, the merchant information can further include one or more of the following: a specification of providers, a merchant acceptance criterion, a maximum rate, a maximum qualified swipe rate, a maximum qualified keyed rate, a maximum fee, a maximum monthly fee, a maximum value of a monthly minimum amount, a maximum cancellation fee, a maximum authorization fee, a maximum chargeback fee, a maximum debit rate, and a maximum base fee. In some embodiments, at least a portion of the merchant information is mandatory.

In some embodiments, the merchant module 252 is further configured to receive a bid request from the merchant 202, and to request the merchant information from the merchant in response to the bid request. The merchant module 252 can be further configured to receive the merchant information from the merchant in response to the request for the merchant information.

The merchant module 252 can be further configured to store the merchant information in the second database 240 (e.g. via the database module 254). The merchant module 252 can be further configured to transmit the merchant information to the provider module 258. The merchant module 252 can be further configured to receive merchant-specific provider information from the provider module 258, and to transmit at least a portion of the merchant-specific provider information to the merchant 202 in response to the merchant's request for provider information. In some embodiments, the transmitted portion of the merchant-specific provider information includes a recommended provider of the payment service providers 206a-206n. In some embodiments, the transmitted portion of the merchant-specific provider information further includes third-party information about the payment service providers 206a-206n. In some embodiments, the transmitted portion of the merchant-specific provider information is a function of merchant acceptance criterion associated with the merchant information.

The merchant module 252 can be further configured to receive a selection of a provider of the one or more providers from the merchant 202 as the selected provider, and to communicate information about the selected provider to the provider module 258.

In some embodiments, the merchant module 252 can be further configured to receive updated merchant-specific information from the provider module 258 (e.g. when the merchant switches to a new payment service provider, such as from the payment service provider 206a to the payment service provider 206b). The merchant module 252 can be further configured to transmit at least a portion of the updated merchant-specific provider information to the merchant 202, and to receive, from the merchant, a selection of a second provider (i.e. a newly selected provider) different from the first provider (i.e. a previously selected provider).

The provider module 258 is configurable to establish and maintain connectivity with the payment service providers 206a-206n. In some embodiments, the provider module 258 is further configurable to receive payment information associated with a transaction by the merchant 202, and to transmit at least a portion of the payment information to the selected provider of the merchant for processing.

In some embodiments, the provider module 258 can be configured to transmit at least a portion of the merchant information (e.g. received from the merchant module 252) to at least one of the providers 206a-206n as a function of the merchant information. In response, the provider module 258 can further receive merchant-specific provider information from the providers 206a-206n and store the merchant-specific provider information in the second database 240 (e.g. via the database module 254). In some embodiments, the provider module 258 can be further configured to register the merchant with a selected provider to generate merchant registration information, and to store the merchant registration information in the second database 240.

In some embodiments, the selected provider is a first provider, and the provider module 258 is further configurable to, after registering the merchant with the selected provider, retransmit the stored merchant information to the providers 206a-206n. The provider module 258 can further receive updated merchant-specific provider information from the providers 206a-n in response to the retransmitting. In some embodiments, the provider module 258 can be further configured to, when the merchant 202 selects a second provider, unregister the merchant from the first provider and register the merchant with the second provider.

In some embodiments, the provider module 258 is further configurable to the provider module is further configured to register the providers 206a-n, by receiving and storing, for each provider, one or more of the following provider information: mandatory merchant information, desirable merchant information, optional merchant information; a fee, a monthly fee, a monthly minimum, a cancellation fee, an authorization fee, a chargeback fee, a debit value, an annual fee, a nuisance fee, a statement fee, a batch fee, an early termination fee, a chargeback fee, a rate, a qualified rate, a qualified swipe rate, a mid-qualified rate, a qualified key rate, a non-qualified rate, a gift card rate, a qualified rate for a particular credit card network, terms and conditions; a corporate logo, provider acceptance criterion, and pre-authorization criterion.

In some embodiments, the provider information associated with the selected provider includes at least the provider acceptance criterion, and the provider module 258 is further configured to register the merchant 202 with the selected provider when the merchant information meets the provider acceptance criterion of the selected provider.

In some embodiments, the selected provider is a first provider, and the provider module 258 is further configured to update the stored provider information, such as when the first provider changes service terms. In such embodiments, the provider module 258 is further configurable to unregister the merchant 202 from the first provider and register the merchant with a second provider selected by the merchant.

The registration module 250 and the user account module 248 can be configured as generally described in the Real-Time Loyalty application, and will not be described in more detail herein.

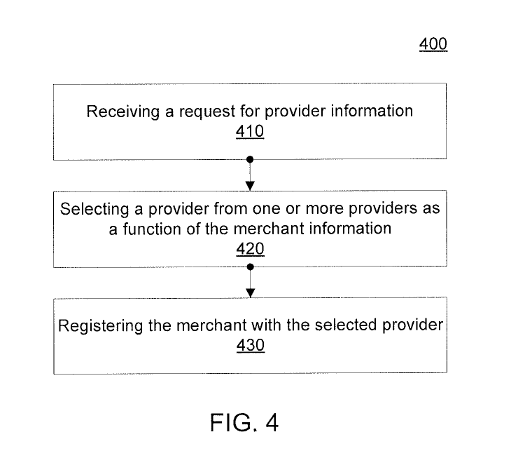

FIG. 4 illustrates a method 400 for selecting a payment provider according to embodiments of the invention, explained herein with respect to FIGS. 1-3. In some embodiments, a computer-readable storage medium storing computer-executable instructions can perform the method 400. At 410, a request for provider information is received from the merchant 202. The request can include merchant information associated with the merchant. The merchant information can include one or more of the following: a first name, a last name, an email address, a business type, an average transaction amount, a business address, an owner address, a business legal name, a doing business as (d/b/a) name, a business legal entity type, a phone number, a duration of operation of business, a highest transaction amount, an owner's social security number, an owner's percentage of equity ownership, a tax identifier, a bank routing number, a bank account number, an owner's date of birth, a specification of provider services desired by the merchant, a selection of a provider, an approval to share the merchant information with the one or more providers, an acceptance of terms and conditions for one or more providers, and account settings of the merchant. In some embodiments, the merchant information can further include one or more of the following: a specification of providers, a merchant acceptance criterion, a maximum rate, a maximum qualified swipe rate, a maximum qualified keyed rate, a maximum fee, a maximum monthly fee, a maximum value of a monthly minimum amount, a maximum cancellation fee, a maximum authorization fee, a maximum chargeback fee, a maximum debit rate, and a maximum base fee. In some embodiments, at least a portion of the merchant information is mandatory.

In some embodiments, a bid request is received from the merchant 202, and the merchant information is requested and subsequently received from the merchant is response to the bid request.

At 420, a provider from the providers 206a-206n is selected as a function of the merchant information. In some embodiments, at least a portion of the merchant information is transmitted to at least one provider of the providers 206a-206n as a function of the merchant information. In response, merchant-specific provider information from the providers 206a-206n is received, and at least a portion of the merchant-specific provider information is transmitted to the merchant 202. A selection of a provider from the providers 206a-206n is then received from the merchant 202.

In some embodiments, the merchant information is compared against stored provider information (e.g. in the second database 240) associated with the providers 206a-206n. At least a portion of the stored provider information is transmitted to the merchant 202 in response to the request for provider information as a function of the comparing. A selection of a provider of the providers 206a-206n from the merchant is received as the selected provider.

At 430, the merchant 202 is registered with the selected provider, e.g. the provider 206a. In some embodiments, the merchant information is stored (e.g. in the first database 220 and/or the second database 240). After registering the merchant 202 with the selected provider, the stored merchant information can be retransmitted to the providers 206a-206n. In response, updated merchant-specific provider information is received, and at least a portion thereof is transmitted to the merchant 202. A selection of a second provider is received from the merchant 202. The merchant 202 is unregistered from the first provider and registered with the second provider.

In some embodiments, the transmitted portion of the merchant-specific provider information includes a recommended provider of the providers 206a-206n. In some embodiments, the transmitted portion of the merchant-specific provider information further includes third-party information about the providers 206a-206n. In some embodiments, the transmitted portion of the merchant-specific provider information is a function of merchant acceptance criterion associated with the merchant information.

In some embodiments, the method 400 further includes registering the providers 206a-206n by receiving and storing, for each provider, one or more of the following provider information: mandatory merchant information, desirable merchant information, optional merchant information; a fee, a monthly fee, a monthly minimum, a cancellation fee, an authorization fee, a chargeback fee, a debit value, an annual fee, a nuisance fee, a statement fee, a batch fee, an early termination fee, a chargeback fee, a rate, a qualified rate, a qualified swipe rate, a mid-qualified rate, a qualified key rate, a non-qualified rate, a gift card rate, a qualified rate for a particular credit card network, terms and conditions; a corporate logo, provider acceptance criterion, and pre-authorization criterion.

In some embodiments, the provider information associated with the selected provider includes at least the provider acceptance criterion, and the registering the merchant 202 includes registering the merchant with the selected provider when the merchant information meets the provider acceptance criterion of the selected provider.

In some embodiments, the selected provider is a first provider, and the method 500 further includes updating stored provider information, and comparing the merchant information against the updated provider information. At least a portion of the updated provider information is transmitted to the merchant 202 as a function of the comparing, and a selection of a second provider of the providers 206a-206n is received from the merchant. The merchant 202 is unregistered from the first provider and is registered with the second provider.

Aspects of the invention described herein allow merchants to reap the benefits of real-time competition between payment service providers for the merchant's business. The merchant can not only pre-filter the providers based on criterion desirable to the merchant (vs. necessarily having to analyze each provider), but can dynamically change providers in response to the merchant's changing needs, based on a change in the selected provider's offering, based on a change in offerings by non-selected providers that might benefit the merchant, and so on. The payment service providers are benefitted by gaining access to a potentially large merchant pool, where even a small fraction of the transactions, if processed by the providers, can provide significant business. In scenarios where the provider can exploit the pre-authorization and registration capabilities of the embodiments described herein, the provider can lower operating costs and overhead. Aspects of the invention also hence permit smaller providers to compete with more prominent, large-scale providers by leveling the technical playing field and accessibility to the merchant pool.

### Example 1

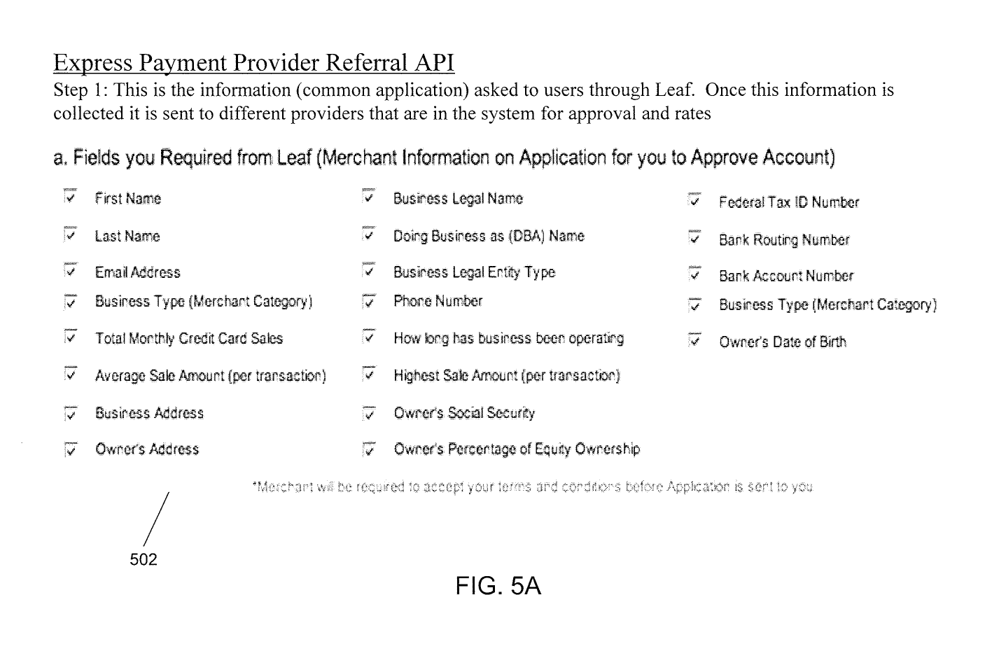

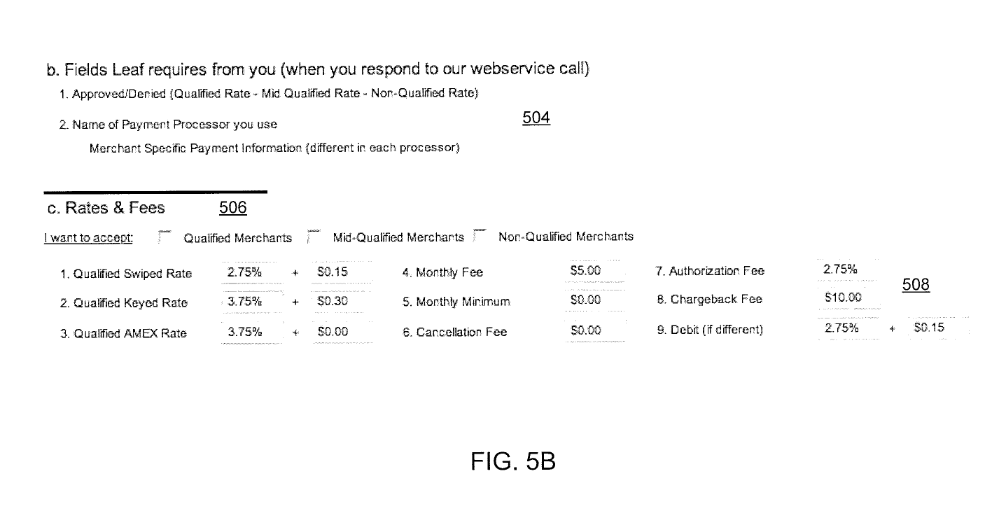

FIGS. 5A-5B are exemplary interfaces for PSP registration. FIG. 5A is an interface for PSP registration showing selectable fields 502 of merchant information that a PSP can specify as mandatory in order to be able to provide a bid to a merchant in response to a bid request. FIG. 5B is an interface specifying merchant-specific provider information that a PSP must provide in response to merchant information/bid request transmitted to the PSP (see generally reference character 504). FIG. 5B also illustrates pre-authorization criterion 506 that a PSP can specify, such as automatic acceptance of merchant bids from merchants that are qualified, mid-qualified, or non-qualified. FIG. 5B also illustrates provider information 508 to be provided by the PSP that includes a specification of various rates and fees.

### Example 2

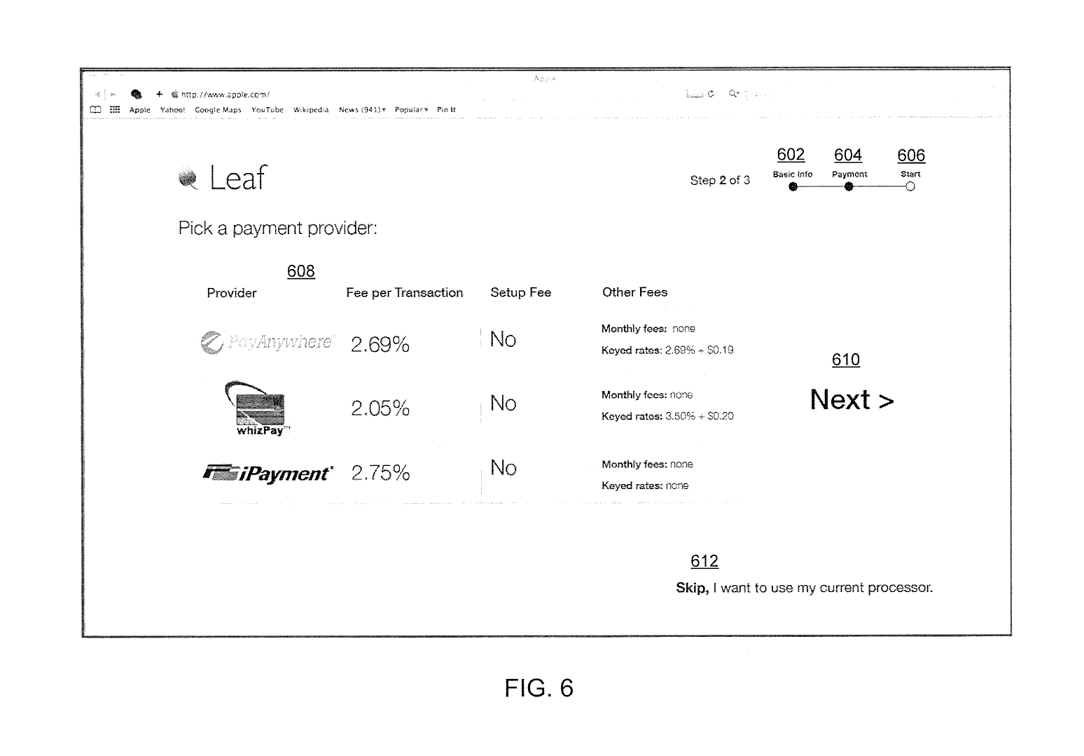

FIG. 6 is an exemplary interface for PSP selection by a merchant. FIG. 6 illustrates the situation wherein a merchant has already provided merchant information in a ‘basic info’ section 602, and is reviewing a selectable listing of PSPs 608 at a ‘payment’ section 604 that also includes merchant-specific PSP information such as fee per transaction, monthly fees, etc. A merchant can then select one of the PSPs and confirm the selection at a clickable link 610 (“Next” button), or opt to stay with a currently selected PSP by selecting another link 612 (“Skip . . . ” button). The merchant can then start using the PSP to process transactions at the next screen 606.

Some embodiments described herein relate to a computer storage product with a non-transitory computer-readable medium (also referred to as a non-transitory processor-readable medium) having instructions or computer code thereon for performing various computer-implemented operations. The computer-readable medium (or processor-readable medium) is non-transitory in the sense that it does not include transitory propagating signals (e.g., a propagating electromagnetic wave carrying information on a transmission medium such as space or a cable). The media and computer code (also referred to herein as code) may be those designed and constructed for the specific purpose or purposes. Examples of non-transitory computer-readable media include, but are not limited to: magnetic storage media such as hard disks, optical storage media such as Compact Disc/Digital Video Discs (CD/DVDs), Compact Disc-Read Only Memories (CD-ROMs), magneto-optical storage media such as optical disks, carrier wave signal processing modules, and hardware devices that are specially configured to store and execute program code, such as Application-Specific Integrated Circuits (ASICs), Programmable Logic Devices (PLDs), Read-Only Memory (ROM) and Random-Access Memory (RAM) devices.

Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using Java, C++, or other programming languages and/or other development tools.

The various embodiments described herein should not to be construed as limiting this disclosure in scope or spirit. It is to be understood that no limitation to the scope of the disclosure is intended thereby. It is to be further understood that resort may be had to various other embodiments, modifications, and equivalents thereof which may suggest themselves to those skilled in the art without departing from the spirit of the present disclosure and/or scope of the appended claims.

Those skilled in the art will recognize, or be able to ascertain, using no more than routine experimentation, numerous equivalents to the specific embodiments described specifically herein. Such equivalents are intended to be encompassed in the scope of the following claims.

1. A method for selecting a payment provider, comprising:
receiving a request for provider information, the request including merchant information associated with a merchant;
selecting a provider from one or more providers as a function of the merchant information; and
registering the merchant with the selected provider.

2. The method of claim 1, the selecting further comprising:
transmitting at least a portion of the merchant information to at least one provider of the one or more providers as a function of the merchant information;
receiving merchant-specific provider information from the one or more providers in response to the transmitting;
transmitting at least a portion of the merchant-specific provider information to the merchant in response to the request for provider information; and
receiving a selection of a provider of the one or more providers from the merchant as the selected provider.

3. The method of claim 2, wherein the selected provider is a first provider, further comprising:
storing the merchant information;
after the registering the merchant with the selected provider, retransmitting the stored merchant information to the one or more providers;
receiving updated merchant-specific provider information from the one or more providers in response to the retransmitting;
transmitting at least a portion of the updated merchant-specific provider information to the merchant;
receiving, from the merchant, a selection of a second provider different from the first provider from the merchant;
unregistering the merchant from the first provider; and
registering the merchant with the second provider.

4. The method of claim 2, wherein the transmitted portion of the merchant-specific provider information further includes a recommended provider of the one or more providers.

5. The method of claim 2, wherein the transmitted portion of the merchant-specific provider information further includes third-party information about the one or more providers.

6. The method of claim 2, wherein the transmitted portion of the merchant-specific provider information is a function of merchant acceptance criterion associated with the merchant information.

7. The method of claim 2, further comprising registering the one or more providers, the registering the one or more providers including receiving and storing, for each provider of the one or more providers, one or more of the following provider information: mandatory merchant information, desirable merchant information, optional merchant information; a fee, a monthly fee, a monthly minimum, a cancellation fee, an authorization fee, a chargeback fee, a debit value, an annual fee, a nuisance fee, a statement fee, a batch fee, an early termination fee, a chargeback fee, a rate, a qualified rate, a qualified swipe rate, a mid-qualified rate, a qualified key rate, a non-qualified rate, a gift card rate, a qualified rate for a particular credit card network, terms and conditions; a corporate logo, provider acceptance criterion, and pre-authorization criterion.

8. The method of claim 7, wherein the provider information associated with the selected provider includes at least the provider acceptance criterion, and wherein the registering the merchant includes registering the merchant with the selected provider when the merchant information meets the provider acceptance criterion of the selected provider.

9. The method of claim 1, the selecting further comprising:
comparing the merchant information against stored provider information associated with the one or more providers; and
transmitting at least a portion of the stored provider information to the merchant in response to the request for provider information as a function of the comparing; and
receiving a selection of a provider of the one or more providers from the merchant as the selected provider.

10. The method of claim 9, wherein the selected provider is a first provider, further comprising:
updating the stored provider information;
comparing the merchant information against the updated provider information; and
transmitting at least a portion of the updated provider information to the merchant as a function of the comparing; and
receiving, from the merchant, a selection of a second provider different from the first provider from the merchant;
unregistering the merchant from the first provider; and
registering the merchant with the second provider.

11. The method of claim 1, further comprising:
receiving payment information associated with a transaction by the merchant;
transmitting at least a portion of the payment information to the selected provider of the merchant for processing.

12. The method of claim 1, wherein the merchant information comprises one or more of the following: a first name, a last name, an email address, a business type, an average transaction amount, a business address, an owner address, a business legal name, a doing business as (d/b/a) name, a business legal entity type, a phone number, a duration of operation of business, a highest transaction amount, an owner's social security number, an owner's percentage of equity ownership, a tax identifier, a bank routing number, a bank account number, an owner's date of birth, a specification of provider services desired by the merchant, a selection of a provider, an approval to share the merchant information with the one or more providers, an acceptance of terms and conditions for one or more providers, and account settings of the merchant.

13. The method of claim 12, wherein the merchant information further comprises one or more of the following: a specification of providers, a merchant acceptance criterion, a maximum rate, a maximum qualified swipe rate, a maximum qualified keyed rate, a maximum fee, a maximum monthly fee, a maximum value of a monthly minimum amount, a maximum cancellation fee, a maximum authorization fee, a maximum chargeback fee, a maximum debit rate, and a maximum base fee.

14. The method of claim 1, wherein at least a portion of the merchant information is mandatory.

15. The method of claim 1, the receiving further comprising:
receiving a bid request from the merchant;
requesting the merchant information from the merchant in response to the bid request; and
receiving the merchant information from the merchant in response to the request for the merchant information.

16. The method of claim 15, wherein at least a portion of the requested merchant information is mandatory.

17. The method of claim 15, wherein at least a portion of the requested merchant information is optional.

18. The method of claim 1, wherein each provider of the one or more providers is independently one of the following: a point-of-sale provider, an aggregator, a credit card network, a bank, a mobile money provider, and a virtual currency provider.

19. A computer-readable storage medium storing computer-executable instructions for performing the method of claim 1.

20. A system for selecting a payment provider, comprising:
one or more databases storing merchant information, merchant-specific provider information, and merchant registration information; and
a processor comprising:
a merchant module configured to:
receive a request for provider information from a merchant, the request including the merchant information associated with the merchant; and
store the merchant information in the one or more databases; and
a provider module configured for:
transmit at least a portion of the merchant information to at least one provider of the one or more providers as a function of the merchant information;
receive merchant-specific provider information from the one or more providers in response to the transmitting; and
store the merchant-specific provider information in the one or more databases,
wherein the merchant module is further configured to:
transmit at least a portion of the merchant-specific provider information to the merchant in response to the request for provider information; and
receive a selection of a provider of the one or more providers from the merchant as the selected provider; and
wherein the provider module is further configured for:
register the merchant with the selected provider to generate merchant registration information; and
storing the merchant registration information in the one or more databases.

21.-36. (canceled)
